(19) United States
(12) Patent Application Publication
(10) Pub. No.: US 2022/0234651 A1
(43) Pub. Date: Jul. 28, 2022

(54) METHODS, SYSTEMS, AND APPARATUSES FOR ADAPTIVE DRIVER OVERRIDE FOR PATH BASED AUTOMATED DRIVING ASSIST

(71) Applicant: GM GLOBAL TECHNOLOGY OPERATIONS LLC, Detroit, MI (US)

(72) Inventors: Wenhao Wu, Thornhill (CA); Jayant Sachdev, Toronto (CA); Bret T. Schulte, Howell, MI (US); Reza Zarringhalam, Whitby (CA)

(73) Assignee: GM GLOBAL TECHNOLOGY OPERATIONS LLC, Detroit, MI (US)

(21) Appl. No.: 17/157,389

(22) Filed: Jan. 25, 2021

(51) Int. Cl. B62D 15/02; G06N 3/04; G06N 3/08

(52) U.S. Cl. CPC B62D 15/025; G06N 3/08; G06N 3/04

(57) ABSTRACT

In various embodiments, methods, systems, and vehicle apparatuses are provided. A method for implementing phases of steering override control in a vehicle using a Deep Neural Network (DNN) including receiving, by a steering assist unit disposed of in the vehicle, a set of vehicle inputs including lane data and vehicle sensor interpretation information and driver steering input; configuring a mission planning module to determine a desired path of the vehicle; configuring a vehicle path prediction module to determine a set of a predicted dynamics of the vehicle; configuring a driver override determination module in communication with the DNN to override the automated steering control torque based on a phase of steering control operation and by information of a corresponding intervention phase classified in the DNN, and configuring a lateral control module to override the steering control torque for automated steering assist based on a determined phase of steering control operation and driver input such as driver steering torque and torque rate.

The technical field generally relates to steering assist methods, systems, and apparatuses and more particularly relates to methods, systems, and apparatuses for intuitive steering override for a vehicle by an interface that at least automatically adjusts a required effort to override a steering invention.

Recent years have seen significant advancements in autonomous and semi-autonomous driving features inland driven vehicles, such as Super Cruise (a hands-free semi-autonomous driver assistance feature that uses high-definition maps and sensors watching the road to assist with accelerating, and decelerating a vehicle), LKA (lane-keeping assist, which is a semi-autonomous driving feature that assists with the steering to keep a vehicle within the lane boundaries or centered in a lane), and others. Vehicles may still be improved in a number of respects.

In continuous hands-on automated steering features (e.g. SuperCruise), a driver's perception of “safety” changes based on the vehicle position and lane conditions. When the vehicle is in a safer operating condition, drivers will perceive less necessity of steering control and prefer a reduced effort to stop an automated steering intervention.

It is desirable to reduce driver effort when utilizing a hands-on automated steering feature and to reduce the overall annoyance of overriding hands-on steering control when the vehicle is in safe conditions, and to interpret different regions of steering control operations based on environmental, path planning, and control algorithm statuses.

It is desirable to provide systems and methods to classify the intervention phase of a steering assist feature, and to determine and adjust the reduction of driver steering override effort based on the region of steering control and classified intervention phase.

Furthermore, other desirable features and characteristics of the present invention will become apparent from the subsequent detailed description and the appended claims, taken in conjunction with the accompanying drawings and the foregoing technical field and background.

### SUMMARY

A method, system, and apparatus for steering assist for a vehicle by adapting vehicle trajectories based upon road geometry, and driving scenario, controlling of intervention exits while considering trajectory tracking, and mitigating over-correction and tracking anomalies are disclosed.

In one exemplary embodiment, a method for implementing phases of steering override control in a vehicle using a Deep Neural Network (DNN) is provided. The method includes receiving, by a steering assist unit disposed in the vehicle, a set of vehicle inputs including lane data interpretation information and driver steering input; configuring a mission planning module disposed in the steering assist unit to use the lane and vehicle sensor data interpretation information to determine at least a desired path of the vehicle; configuring a vehicle path prediction module disposed in the steering assist unit to use the lane data interpretation information to determine at least a set of a predicted dynamics of the vehicle; configuring a driver override determination module disposed in the steering assist unit and in communication with the DNN to intervene with an override steering control based on a phase of steering control operation determined in part by the desired path and predicted dynamics of the vehicle, and by information of a corresponding intervening phase classified in the DNN; and in response to a determination to override the automated steering control, configuring a lateral control module disposed in the steering assist unit, to cease to apply steering control torque for automated steering assist based on a determined phase of steering control operation and the determined driver intervention level through the amount of driver applied torque and torque rate.

In at least one exemplary embodiment, the method includes configuring the mission planning module disposed of in the steering assist unit to use the lane data and vehicle sensor interpretation information to determine a desired trajectory path of the vehicle.

In at least one exemplary embodiment, the method includes configuring the vehicle path prediction module disposed of in the steering assist unit to use the lane data and vehicle sensor interpretation information to determine the current predicted path of the vehicle.

In at least one exemplary embodiment, the method includes configuring the driver override determination module with a vehicle curvature determination module for generating a set of curvature parameters, and a vehicle heading and position module for generating a set of heading parameters to store in a decision matrix for use in determining when to override the current active automated steering control for varying amounts of driver input, such as the driver applied to steer torque and torque rate.

In at least one exemplary embodiment, the method includes configuring a labeling module to label data offline to send labeled data to the DNN, and in response to a control command assist torque signal to determine the corresponding classified phase of steering control operation, and utilize the classified phase information to varying amount of steering override torque thresholds by the driver override determination module.

In at least one exemplary embodiment, the method includes configuring a lateral control module to generate steering control torque based at least on inputs including the desired path of the vehicle, the predicted dynamics of the vehicle, and a driver override flag.

In at least one exemplary embodiment, the driver override flag is generated by the driver override determination module.

In another exemplary embodiment, a system is provided. The system includes a processing unit disposed in a vehicle including one or more processors configured by programming instructions encoded on non-transient computer-readable media in communication with a Deep Neural Network (DNN), the processing unit configured to: receive a set of vehicle inputs including lane data interpretation information and driver steering input; determine at least a desired path of the vehicle based on the lane data and vehicle sensor interpretation information; determine at least a set of a predicted dynamics of the vehicle based on the lane data and vehicle sensor interpretation information; override the automated steering control torque based on a phase of steering control operation determined in part by the desired path and predicted dynamics of the vehicle, and by information of a corresponding intervening phase classified in the DNN; and in response to a determination to override the automated steering control, cease application of the automated steering control torque for steering assist based on a determined phase of steering control operation and the determined driver intervention level, which includes the amount of driver applied torque and torque rate.

In at least one exemplary embodiment, the system includes the processing unit configured to determine a desired path of the vehicle based on the lane data and vehicle sensor interpretation information.

In at least one exemplary embodiment, the system includes the processing unit configured to determine a path of the vehicle based on the lane data interpretation information.

In at least one exemplary embodiment, the system includes the processing unit configured to generate a set of curvature parameters and a set of heading parameters to store in a decision matrix to determine when to override the automated steering control torque through the application of a variable driver override threshold, applied through driver input including driver steering torque and torque rate.

In at least one exemplary embodiment, the system includes the processing unit configured to send labeled data determined offline to the DNN, and in response to a control command torque-assist signal, send classified intervention phase information corresponding to a region to apply the variable amount of driver steering torque override threshold.

In at least one exemplary embodiment, the system includes the processing unit configured to: generate steering control torque based at least on a set of inputs including the desired path of the vehicle, the predicted dynamics of the vehicle, and a driver override flag.

In at least one exemplary embodiment, the system includes the processing unit configured to: generate a driver override flag based at least on a set of inputs including the desired path of the vehicle, the predicted dynamics of the vehicle, and the driver input.

In yet another exemplary embodiment, a vehicle apparatus is provided. The apparatus includes a steering assist unit including one or more processors and non-transient computer-readable media encoded with programming instructions, the steering assist unit is configured to receive a set of vehicle inputs including lane data and vehicle sensor interpretation information and driver steering input; determine at least a desired path of the vehicle based on use the lane data and vehicle sensor interpretation information; determine at least a set of a predicted dynamics of the vehicle based on the lane data and vehicle sensor interpretation information; override the automated steering control torque based on a phase of steering control operation determined in part by the desired path and predicted dynamics of the vehicle, and by the information of a corresponding intervening phase classified in a DNN; and in response to a determination to override the automated steering control torque, cease application of a variable amount of steering control torque for steering assist based on a determined phase of steering control operation and the variable amount of driver input into the vehicle control systems.

In at least one exemplary embodiment, the vehicle apparatus further includes the steering assist unit configured to determine a blended path of the vehicle based on the lane data and vehicle sensor interpretation information; and determine a path of the vehicle based on the lane data and vehicle sensor interpretation information.

In at least one exemplary embodiment, the vehicle apparatus further includes the steering assist unit configured to generate a set of curvature parameters and a set of heading parameters to store in a decision matrix to determine when to override the automated steering control torque based on a variable amount of driver input wherein the input includes driver steering torque and torque rate.

In at least one exemplary embodiment, the vehicle apparatus further includes the steering assist unit configured to send labeled data determined offline to the DNN, and in response to a control command torque-assist signal, send classified intervention phase information corresponding to a region to varying the driver override thresholds that includes the driver applied to steer torque and torque rate.

In at least one exemplary embodiment, the vehicle apparatus further includes the steering assist unit configured to: generate steering control torque based at least on a set of inputs including the desired path of the vehicle, the predicted dynamics of the vehicle, and a driver override flag.

In at least one exemplary embodiment, the vehicle apparatus further includes the steering assist unit configured to generate a driver override flag based at least on a set of inputs including the desired path of the vehicle, the predicted dynamics of the vehicle, and a driver override flag.

### BRIEF DESCRIPTION OF THE DRAWINGS

The exemplary embodiments will hereinafter be described in conjunction with the following drawing figures, wherein like numerals denote like elements, and wherein:

FIG. 1 illustrates a block diagram depicting an example vehicle that may include a processor for the path based automated driving assist of vehicle operations implemented by an adaptive driver override system in accordance with an exemplary embodiment;

FIG. 2 illustrates an exemplary diagram of parameters calculated for the path based automated driving assist of vehicle operations implemented by an adaptive driver override system in accordance with an exemplary embodiment;

FIG. 3 illustrates an exemplary diagram of the control architecture for the path based automated driving assist of vehicle operations implemented by an adaptive driver override system in accordance with an exemplary embodiment;

FIG. 4 illustrates an exemplary diagram for the path based automated driving assist of vehicle operations implemented by an adaptive driver override system in accordance with an exemplary embodiment;

FIG. 5 illustrates an exemplary diagram of features for the path based automated driving assist of vehicle operations implemented by an adaptive driver override system in accordance with an exemplary embodiment;

FIG. 6 illustrates an exemplary diagram of offline data labeling used for the path based automated driving assist of vehicle operations implemented by an adaptive driver override system in accordance with an embodiment;

FIGS. 7A and 7B illustrate exemplary diagrams of features for the path based automated driving assist of vehicle operations implemented by an adaptive driver override system; and

FIG. 8 illustrates an exemplary flowchart for the path-based automated driving assist of vehicle operations implemented by an adaptive driver override system in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description.

As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

Autonomous and semi-autonomous vehicles are capable of sensing their environment and navigating based on the sensed environment. Such vehicles sense their environment using multiple types of sensing devices such as optical cameras, radar, lidar, other image sensors, and the like. In such vehicles, the sensed data can be fused together with map data and vehicle sensors (Inertial Measurement unit, vehicle speed sensors, etc.) to identify and track vehicle trajectory tracking performance based on road geometry.

The present disclosure describes methods, systems, and apparatuses for intuitive steering override for a vehicle by an interface that at least automatically adjusts a required effort to override a steering invention, classifies an intervention phase of steering assist feature based on learned behavior, determines and adjusts driver steering override effort based a continuous range operating conditions and adjusts steering override effort based on control, path planning, and prediction parameters.

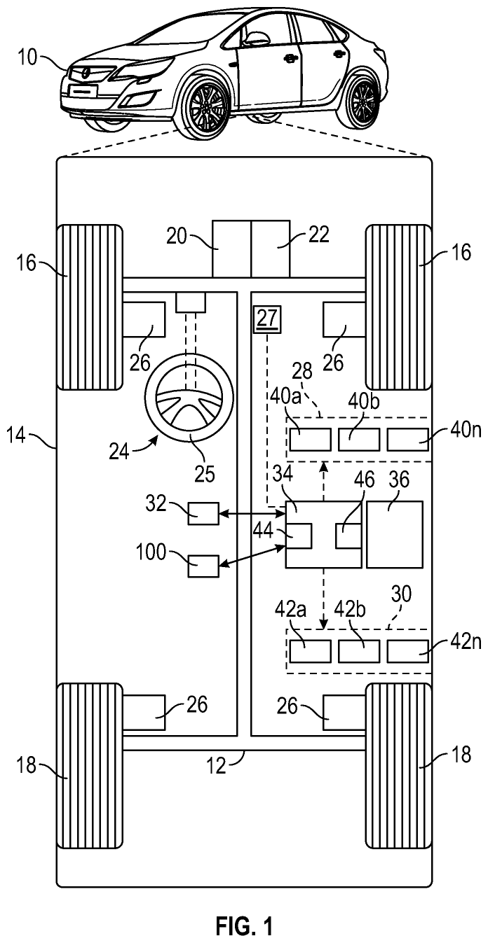

FIG. 1 illustrates a block diagram depicting an example vehicle that may include a processor for determining a variable range of driver steering override effort that includes the feature of continually varying the override effort in response to the road geometry and vehicle dynamics, continually varying the override effort in response to the geometry of a desired path and predicted vehicle dynamics, continually varying the override effort in response to differences of instantaneous vehicle operating conditions versus a predicted path, training a DNN and classifying an intervention phase of a steering assist operation similar to what is perceived by a human driver, and adjusting the steering override effort based on the classified steering assist phase which is learned by a DNN by driving assist system 100. The system 100 implements continued hands-on automated steering features (e.g. SuperCruise) that correspond to a driver's perception of “safety” and changes based on the vehicle position within the lane boundary and road geometry and conditions.

For example, in an exemplary embodiment, when the vehicle is in a safer operating condition, drivers will perceive less necessity of steering control, and expect reduced effort to stop intervention. Accordingly, the system 100 reduces the driver's effort in utilizing a hands-on automated steering feature. This, in turn, reduces the driver's overall annoyance of hands-on steering control, when driver intent differs from that of the automated driving feature, that has been implemented by the system 100 when the vehicle is operating in a safe condition.

In an exemplary embodiment, the system 100 implements continued hands-on automated steering features (e.g. SuperCruise) that can correspond to a driver's perception of “safety” changes based on the vehicle position and lane conditions. The system 100, when the vehicle is in a safer operating condition based on the vehicle position within the lane boundary and/or road geometry and lane conditions, will react to the driver's perception of less necessity of steering control, and expected reduction in effort required to stop an intervention. The system 100 may also reduce driver effort when utilizing other related hands-on automated steering features to reduce the overall annoyance of hands-on steering control when the vehicle is in such safe conditions.

As depicted in FIG. 1, the vehicle 10 generally includes a chassis 12, a body 14, front wheels 16, and rear wheels 18. The body 14 is arranged on chassis 12 and substantially encloses components of the vehicle 10. The body 14 and the chassis 12 may jointly form a frame. The vehicle wheels 16-18 are each rotationally coupled to the chassis 12 near a respective corner of the body 14. The vehicle 10 is depicted in the illustrated embodiment as a passenger car. Still, it should be appreciated that any other vehicle, including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in this example, includes an electric machine such as a permanent magnet (PM) motor. The transmission system 22 is configured to transmit power from the propulsion system 20 to the vehicle wheels 16 and 18 according to selectable speed ratios.

The brake system 26 is configured to provide braking torque to the vehicle wheels 16 and 18. Brake system 26 may, in various exemplary embodiments, include friction brakes, brake by wire, a regenerative braking system such as an electric machine, and/or other appropriate braking systems.

The steering system 24 influences the position of the vehicle wheels 16 and/or 18. While depicted as including a steering wheel 25 for illustrative purposes, in some exemplary embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10 and generate sensor data relating thereto.

The actuator system 30 includes one or more actuator devices 42a-42n that control one or more vehicle features such as, but not limited to, the propulsion system 20, the transmission system 22, the steering system 24, and the brake system 26. In various exemplary embodiments, the vehicle 10 may also include interior and/or exterior vehicle features not illustrated in FIG. 1, such as various doors, a trunk, and cabin features such as air, music, lighting, touch-screen display components, and the like.

The data storage device 32 stores data for use in controlling the vehicle 10. The data storage device 32 may be part of the controller 34, separate from the controller 34, or part of the controller 34 and part of a separate system.

The controller 34 includes at least one processor 44 (integrate with system 100 or connected to the system 100) and a computer-readable storage device or media 46. The processor 44 may be any custom-made or commercially available processor, a central processing unit (CPU), a graphics processing unit (GPU), an application-specific integrated circuit (ASIC) (e.g., a custom ASIC implementing a neural network), a field-programmable gate array (FPGA), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

For example, the system 100 may include any number of additional sub-modules embedded within the controller 34, which may be combined and/or further partitioned to similarly implement systems and methods described herein. Additionally, inputs to the system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

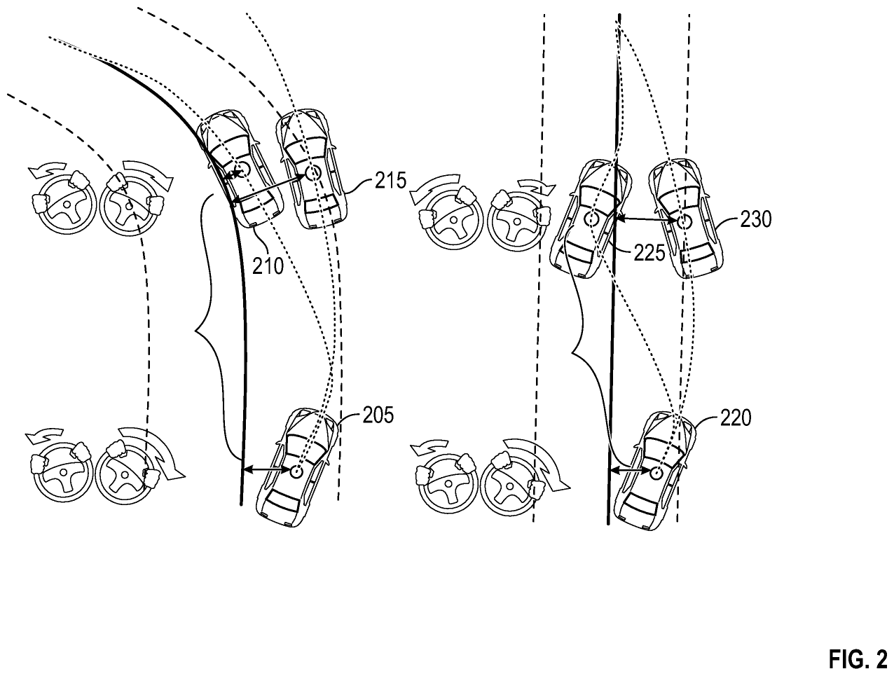

FIG. 2 illustrates an exemplary diagram of parameters calculated for the path based automated driving assist of vehicle operations implemented by an adaptive driver override system in accordance with an exemplary embodiment. FIG. 2 includes the torque parameter calculations by system 100 (of FIG. 1) as follows:

τ_{OvrdLt}=τ_{Cal}*G_{Lt}(X, Y_{Hdng}, Y_{isCurve});

τ_{OvrdRt}=τ_{Cal}*G_{Rt}(X, Y_{Hdng}, Y_{isCurve}), and

X=[Δy Δρ Δy_{VPP} Δρ_{VPP} Δy_{BP} Δρ_{BP} y(0) ρ(0) P].

In an exemplary embodiment, curvature heading determination by system 100 is as follows:

$${Y}_{Hdng} = \{ \begin{matrix}- 1 ( inner ) & {K}_{Hdng} < α \\ 0 ( center ) & α \leq {K}_{Hdng} \leq β \\ 1 ( outer ) & {K}_{Hdng} > β\end{matrix} \\ where \\ {K}_{Hdng} = f ( X ) = {A}_{Hdng} X \\ {Y}_{isCurve} = 1$$

For right curves α, β, are opposite signs compared to left curves

In an exemplary embodiment, steering effort is continually adjusted by system 100 as follows:

τ_{OvrdLt}=τ_{CAL}+τ_{Adj}(X, P)

τ_{OvrdRt}=−τ_{CAL}−τ_{Adj}(X, P)

τ_{OvrdLt}=τ_{CAL}+τ_{AdjCrv}(X, Y_{Hdng}, P)

τ_{OvrdRt}=−τ_{CAL}−τ_{AdjCrv}(X, Y_{Hdng}, P)

τ_{Adj} can be defined as linear (functions or gains) or Nonlinear (stepwise functions or lookup tables).

In an exemplary embodiment, curvature determination is as follows:

$${Y}_{isCurve} = \{ \begin{matrix}1 & {K}_{isCurve} ( X ) \geq C \\ 0 & {K}_{isCurve} ( X ) < C\end{matrix}$$

The curvature heading determination is as follows:

$${Y}_{Hdng} = \{ \begin{matrix}- 1 ( inner ) & {K}_{Hdng} < α \\ 0 ( center ) & α \leq {K}_{Hdng} ( X ) \leq β \\ 1 ( outer ) & {K}_{Hdng} ( X ) > β\end{matrix}$$

In an exemplary embodiment, the input state definition is as follows:

$$X = {[ \begin{matrix}Δ y \\ Δ ρ \\ Δ {y}_{VPP} \\ Δ {ρ}_{VPP} \\ Δ {y}_{BP} \\ Δ {ρ}_{BP} \\ y ( 0 ) \\ ρ ( 0 ) \\ P\end{matrix} ]}^{T} = {[ \begin{matrix}{y}_{BP} ( {t}_{L A} ) - {y}_{VPP} ( {t}_{LA} ) \\ {ρ}_{BP} ( {t}_{LA} ) - {ρ}_{VPP} ( {t}_{LA} ) \\ {y}_{VPP} ( {t}_{LA} ) - y ( 0 ) \\ {ρ}_{VPP} ( {t}_{LA} ) - ρ ( 0 ) \\ {y}_{BP} ( {t}_{LA} ) - y ( 0 ) \\ {ρ}_{BP} ( {t}_{LA} ) - ρ ( 0 ) \\ y ( 0 ) \\ ρ ( 0 ) \\ P\end{matrix} ]}^{T}$$

where τ_{OvrdLt}, τ_{OvrdRt} is the total override driver steering wheel torque value, left side and right side;

where τ_{Cal} is a statically assigned override driver steering wheel torque value;

where Y_{Hdng}, Y_{isCurve} are logical/state parameters indicating the status of vehicle heading and vehicle is in a curve;

where K_{isCurve} is a function of state X to determine vehicle curvature coefficient;

where C is a curvature coefficient threshold that determines the state value of Y_{isCurve};

where K_{Hdng} is a Function of state X to determine vehicle heading coefficient; and

where α, β is a heading of coefficient thresholds that determines the state value of Y_{Hdng}.

In addition y is a lateral position of the vehicle relative to the calculated center of the traveling lane, a function of time relative to the present operation;

ρ is a curvature of the line of trajectory, a function of time to the present operation;

P is a phase classification information;

τ_{LA} is a predetermined value of time in the future, used as the steering control look ahead time;

X is an input matrix;

G_{Lt}( ), G_{Rt}( ) are configurable gain function states X;

BP is a subscript indicating the vehicle's “blend path” or steering control desired predicted trajectory; and

VPP is a subscript indicating the “vehicle predicted path” or vehicle dynamics based on a predicted trajectory.

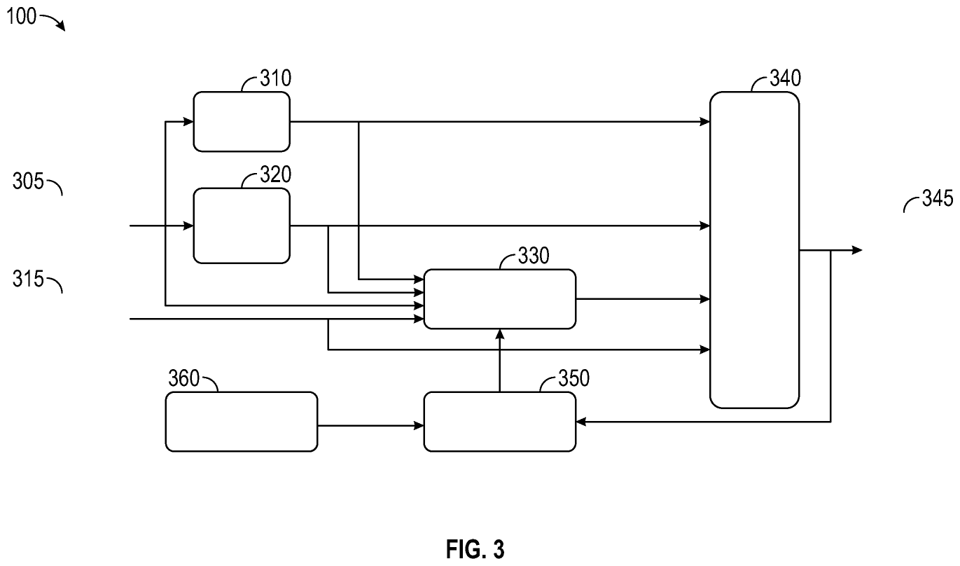

FIG. 3 illustrates an exemplary diagram of the control architecture for the path-based automated driving assist of vehicle operations implemented by an adaptive driver override system in accordance with an exemplary embodiment. In FIG. 3, the system 100 (of FIG. 1) includes the input of lane data and vehicle sensor interpretations 305 to the system 100 to a mission planning module 310, a vehicle path prediction module 320 and a driver override determination module 330. The driver override determination module 330 also receives an input of a driver steering input 315. The mission planning module generates the desired path and sends the information to the driver override determination module 330 and a lateral controls module 340. The vehicle path prediction module 320 generates vehicle predicted dynamics and path information to the lateral controls module 340 and the driver override determination module 330.

The driver override determination module 330 receives a set of multiple inputs for processing consisting of the driver steering input 315, the lane data and vehicle sensor interpretation 305, vehicle predicted dynamics and path information generated by the vehicle path prediction module 320, desired path information generated by the mission planning module 310, and classified intervention phase information contained in a deep neural network 350 based in part on offline labeled data from the offline labeled data module 360. The driver overrides determination module 330 processes the multiple input information and generates driver override information to the lateral controls module 340.

The lateral controls module 340 based on information processed from the set of inputs consisting of driver steering input 315 information, driver flag information generated by the driver override determination module 330, vehicle predicted dynamics, and path information generated by the vehicle path prediction module 320, and desired path information generated by the mission planning module 310, processes the set of inputs to generate the steering control torque 345.

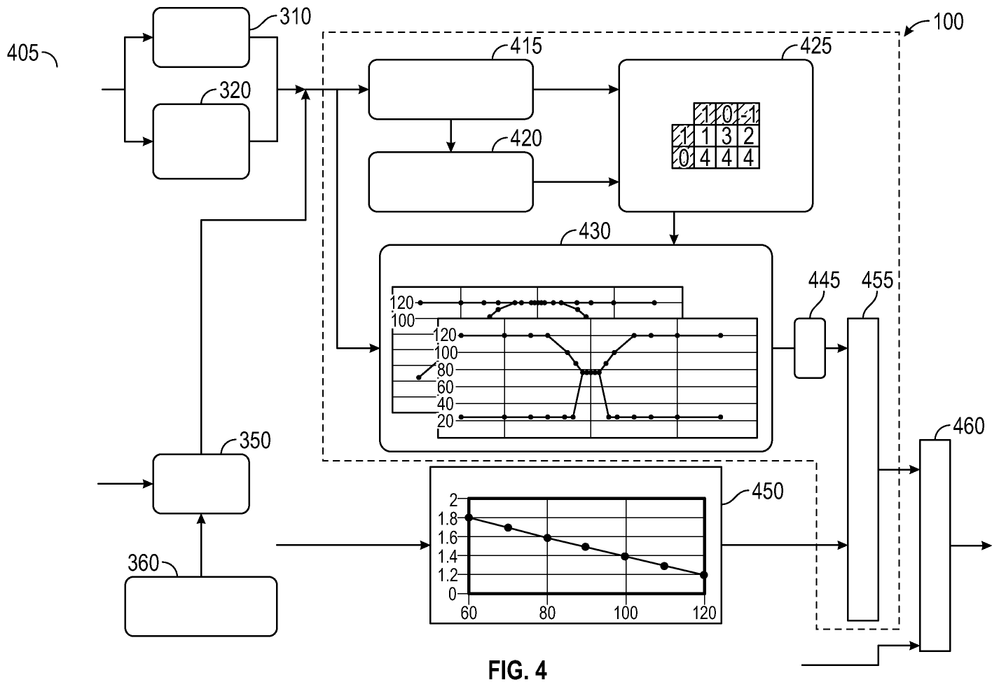

FIG. 4 illustrates an exemplary diagram for the path based automated driving assist of vehicle operations implemented by an adaptive driver override system in accordance with an exemplary embodiment. In FIG. 4, elements of the driver override determination module 330 (of FIG. 3) are illustrated in more detail. In FIG. 4, the input of lane data and vehicle sensor interpretation from vehicle sensors 405 are received by the mission planning module 310 and the vehicle path prediction module 320. Both modules, mission planning module 310 and the vehicle path prediction module 320 generate desired path information and vehicle predicted dynamics information (i.e. information referred to as at location “X” in FIG. 4), directly and indirectly for processing to a set of elements of the override determination module 330 that include a vehicle curvature determination module 415, a vehicle heading and position module 420, a gain scheduler module 430, and decision and indexing module 425.

In an exemplary embodiment, the vehicle curvature determination module 415 receives input from the location “X” and generates Y_{isCurve} information to a decision and indexing module 425 and the vehicle heading and position module 420. The vehicle heading and position module 420 generates Y_{Hdng} information to the decision and indexing module 425. The Y_{isCurve} information, and the Y_{Hdng} information are indexed for retrieval in a matrix contained in the decision and indexing module 425 for sending to the gain scheduler module 430. The gain scheduler module 430 also receives as input desired path information and vehicle predicted dynamics information via location “X”. The output from the gain scheduler module 430 is summed at function 445 for processing by function 455 (multiplier) with the input of Torque τ_{Cal} calculations 450 derived from the vehicle speed Vₓ. The output from function 455 is compared to the input of driver steering τ_{Drvr} to determine an override flag for use by the lateral controls module 340 (FIG. 3) for steering control torque.

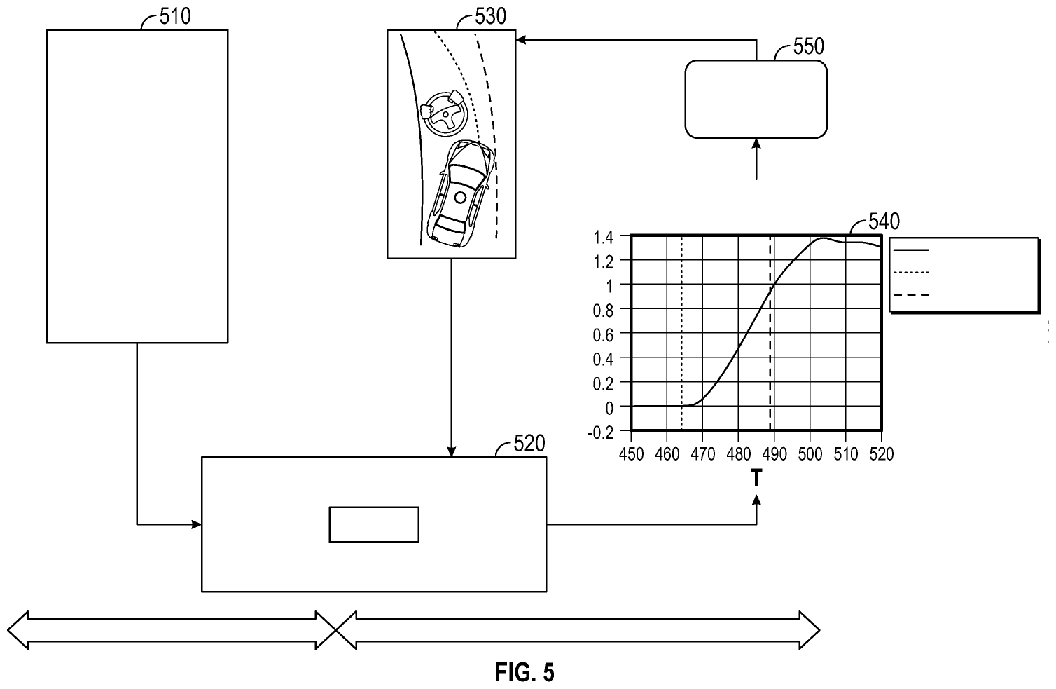

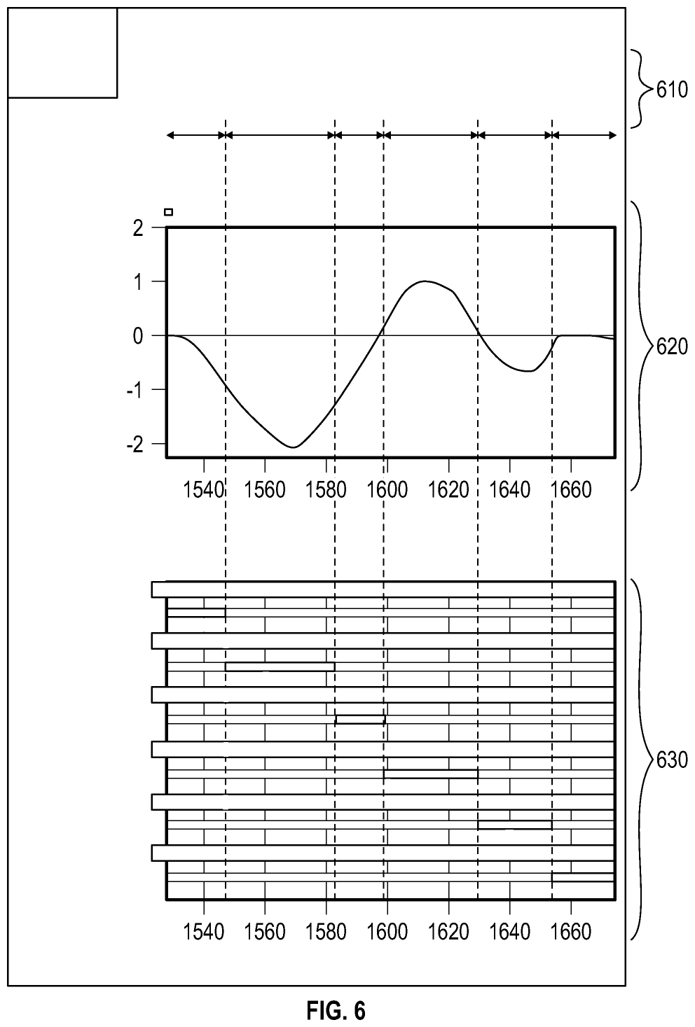

FIG. 5 illustrates an exemplary diagram of features for the path-based automated driving assist of vehicle operations implemented by an adaptive driver override system in accordance with an exemplary embodiment. In FIG. 5, features configured offline or online are represented in the system 100. In FIG. 5, there is illustrated an offline labeling module 510 (shown in more detail in FIG. 6) for labeling that is configured offline and updated online for a series of regions and settings of vehicle operations. Module 530 represents a vehicle state for intervention and assist in torque in real-time in a lane operation. Module 520 represents a neural network configured to store data of the labeled intention phase data that is trained offline and validated. Further module 520 generates classified intervention phase information in realtime based in part on real-time (on-line) operation information of vehicle operations such as in module 530 of an intervention state and assist torque applied. Finally, module 540 represents a graph of a classified intervention and assist torque that is sent for a driver override determination 550 for applying for configuring the intervention state and assist torque in module 530 in real-time (online).

FIG. 6 illustrates an exemplary diagram of offline data labeling used for the path-based automated driving assist of vehicle operations implemented by an adaptive driver override system in accordance with an embodiment. FIG. 6 in the exemplary diagram shows a series of intervention phases 610 of max correction, steer back, inactive, ramp up, approach, and settling that correspond to graph 620 and a bar chart 630 showing torque levels.

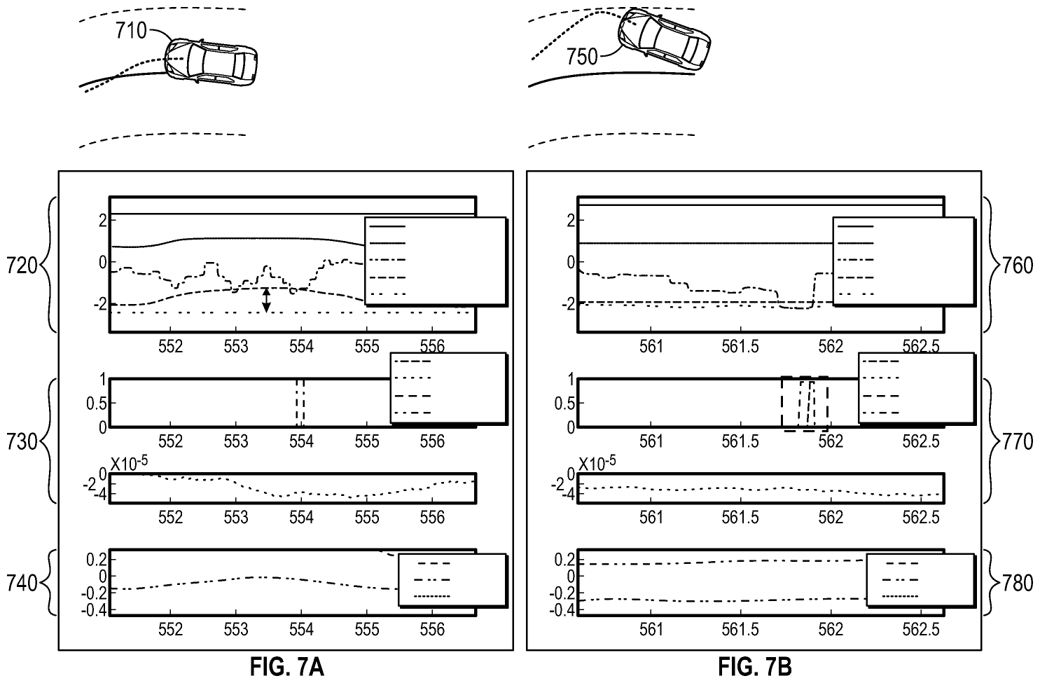

FIGS. 7A and 7B illustrate exemplary diagrams of features for the path-based automated driving assist of vehicle operations implemented by an adaptive driver override system. In FIG. 7A, there is shown a vehicle 710 that is in a safe position location configured with reduced driver thresholds and new detection stops control. There is shown a corresponding to the vehicle safe position: torque to drive torque and override limits graph 720, curvature to driver override flags graph 730, and distance to vehicle position graph 740. In FIG. 7B, there is shown a vehicle 750 in an unsafe position location configured with a large intervention torque, increased driver thresholds, and a new detection similar to previous behavior. There is shown a corresponding to the vehicle unsafe position: torque to drive torque and override limits graph 760, curvature to driver override flags graph 770, and distance to vehicle position graph 780.

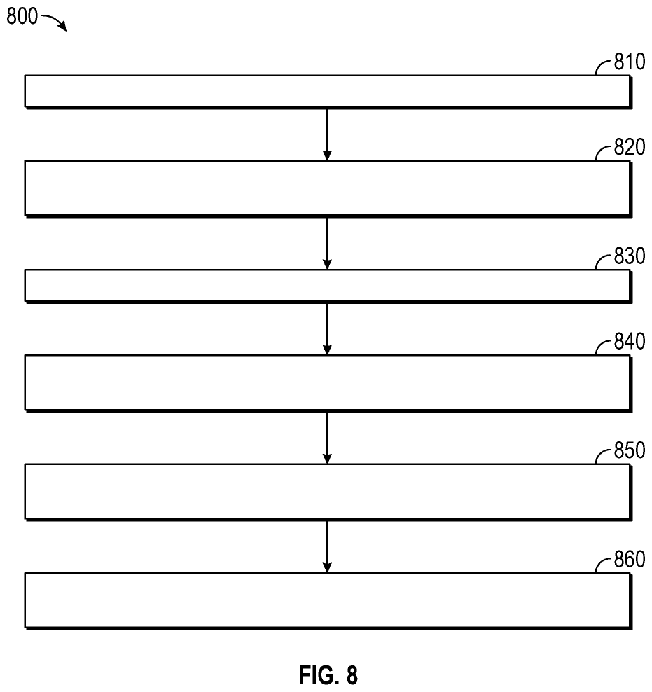

FIG. 8 illustrates an exemplary flowchart for the path-based automated driving assist of vehicle operations implemented by an adaptive driver override system in accordance with an embodiment. The flowchart 800 illustrates the path-based automated assist operational tasks for the adaptive driver override that include the following tasks: Task 810 to determine a variable range of driver steering override effort based on a set of vehicle inputs including lane data and vehicle sensor interpretation information, such as driver steering input, by a driver override determination module in communication with the DNN to override the automated steering control based torque based on a phase of steering control operation determined by the desired path and predicted dynamics of the vehicle, and by the information of a corresponding intervening phase classified in the DNN. Task 820 to continually vary the override effort in response to the road geometry and vehicle dynamics by determining desired paths, and predicted dynamics of the vehicle. Task 830 to continually vary the override effort in response to the geometry of a predicted path and predicted vehicle dynamics using lateral control module disposed of in the steering assist unit, cease application of the automated and the determined driver intervention level through, for example, the amount of driver applied torque and torque rate to override the steering control torque for automated steering assist based on a determined phase of steering control operation and driver input such as driver steering torque and torque rate.

Task 840 to continually vary the override effort in response to differences of instantaneous vehicle operating conditions compared to a predicted path. Task 850 to train a DNN and classify the intervention phase of a steering assist operation similar to what is perceived by a human driver. Task 860 to adjust the steering override effort based on the classified steering assist phase which is learned by a DNN by using labeled data created offline sent to the DNN, and in response to a control command torque-assist signal, sending classified intervention phase information corresponding to a region to vary the threshold of driver steering torque by the driver override determination module.

The deep neural network is used in the adaptive driver override system to inform the torque characteristics and is configured as an already trained neural network. Hence, in certain embodiments, the process of the torque prediction system is configured in an operational mode only. For example, in various embodiments, the deep neural network is trained during a training mode prior to use or provisioned in the vehicle (or other vehicles). Once the deep neural network is trained, it may be implemented in a vehicle (e.g., the vehicle 10 of FIG. 1) in an operational mode, in which the vehicle is operated in an autonomous, semi-autonomous or manual manner.

In various alternative exemplary embodiments, it will be appreciated that the neural network may also be implemented in both the training mode and the operational mode in a vehicle and trained during an initial operation period in conjunction with operations of a time delay or like methodology for torque control predictions. Also, a vehicle may operate solely in the operating mode with neural networks that have already been trained via a training mode of the same vehicle and/or other vehicles in various embodiments.

As mentioned briefly, the various modules and systems described above may be implemented as one or more machine learning models that undergo supervised, unsupervised, semi-supervised, or reinforcement learning. Such models might be trained to perform classification (e.g., binary or multiclass classification), regression, clustering, dimensionality reduction, and/or such tasks. Examples of such models include, without limitation, artificial neural networks (ANN) (such as a recurrent neural network (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation-maximization, hierarchical clustering, etc.), and linear discriminant analysis models.

In various exemplary embodiments, the present disclosure describes a method for implementing phases of steering override control in a vehicle using a Deep Neural Network (DNN) is provided. This method includes receiving, by a steering assist unit disposed of in the vehicle, a set of vehicle inputs includes lane data and vehicle sensor interpretation information, including driver steering input; configuring a mission planning module disposed of in the steering assist unit to use the lane data and vehicle sensor interpretation information to determine at least a desired path of the vehicle; configuring a vehicle path prediction module disposed of in the steering assist unit to use the lane data and vehicle sensor interpretation information to determine at least a set of a predicted dynamics of the vehicle; configuring a driver override determination module disposed of in the steering assist unit and in communication with the DNN to override an automated steering control torque based on a phase of steering control operation determined in part by the desired path and predicted dynamics of the vehicle, and by information of a corresponding intervening phase classified in the DNN; in response to a determination of a lateral control module disposed of in the steering assist unit, enabling an automated configuring of an override steering control module to cease application of the automated steering; and in response to a determination of the lateral control module disposed of in the steering assist unit, determining a driver intervention level of an amount of driver applied torque and torque rate, and a phase of steering control operation and driver input wherein the driver input includes driver steering torque and torque rate to override the steering control torque for automated steering assist.

The present disclosure also describes a method that includes configuring the mission planning module disposed of in the steering assist unit to use the lane data and vehicle sensor interpretation information to determine a blended path of the vehicle and configuring the vehicle path prediction module disposed of in the steering assist unit to use the lane data and vehicle sensor interpretation information to determine a path of the vehicle.

The present disclosure also describes configuring the driver override determination module with a vehicle curvature determination module to generate a set of curvature parameters, and a vehicle heading and position module to generate a set of heading parameters to store in a decision matrix wherein both sets of parameters are used to determine when to implement an override action by the steering assist unit, the automated steering control torque applied based on a determined phase of steering control operation and driver inputs wherein the driver inputs include driver steering torque and torque rate.

The present disclosure also describes configuring a labeling module to label data offline to send labeled data to the DNN, in response to a control command assist torque signal, sending classified intervention phase information corresponding to a region to apply a varying amount of steering override torque by the driver override determination module, and configuring a lateral control module to generate steering control torque based at least on inputs includes the desired path of the vehicle, the predicted dynamics of the vehicle, and a driver override flag wherein the driver override flag is generated by the driver override determination module.

It should be appreciated that process of FIGS. 1-8 may include any number of additional or alternative tasks, the tasks shown in FIGS. 1-8 need not be performed in the illustrated order and process of the FIGS. 1-8 may be incorporated into a more comprehensive procedure or process having additional functionality not described in detail herein. Moreover, one or more of the tasks shown in FIGS. 1-8 could be omitted from an embodiment of the process shown in FIGS. 1-8 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or exemplary embodiments are only examples and are not intended to limit the scope, applicability, or configuration of the disclosure in any way. Rather, the foregoing detailed description will provide those skilled in the art with a convenient road map for implementing the exemplary embodiment or exemplary embodiments.

It should be understood that various changes can be made in the function and arrangement of elements without departing from the scope of the disclosure as set forth in the appended claims and the legal equivalents thereof.

What is claimed is:

1. A method for implementing phases of steering override control in a vehicle using a Deep Neural Network (DNN) comprising:
receiving, by a steering assist unit disposed of in the vehicle, a set of vehicle inputs comprising lane data and vehicle sensor interpretation information, including driver steering input;
configuring a mission planning module disposed of in the steering assist unit to use the lane data and vehicle sensor interpretation information to determine at least a desired path of the vehicle;
configuring a vehicle path prediction module disposed of in the steering assist unit to use the lane data and vehicle sensor interpretation information to determine at least a set of a predicted dynamics of the vehicle;
configuring a driver override determination module disposed of in the steering assist unit and in communication with the DNN to override an automated steering control torque based on a phase of steering control operation determined in part by the desired path and predicted dynamics of the vehicle, and by information of a corresponding intervening phase classified in the DNN;
in response to a determination of a lateral control module disposed of in the steering assist unit, enabling an automated configuring of an override steering control module to cease application of the automated steering; and
in response to a determination of the lateral control module disposed of in the steering assist unit, determining a driver intervention level of an amount of driver applied torque and torque rate, and a phase of steering control operation and driver input wherein the driver input comprises driver steering torque and torque rate to override the steering control torque for automated steering assist.

2. The method of claim 1, further comprising:
configuring the mission planning module disposed of in the steering assist unit to use the lane data and vehicle sensor interpretation information to determine a blended path of the vehicle.

3. The method of claim 2, further comprising:
configuring the vehicle path prediction module disposed of in the steering assist unit to use the lane data and vehicle sensor interpretation information to determine a path of the vehicle.

4. The method of claim 3, further comprising:
configuring the driver override determination module with a vehicle curvature determination module to generate a set of curvature parameters, and a vehicle heading and position module to generate a set of heading parameters to store in a decision matrix wherein both sets of parameters are used to determine when to implement an override action by the steering assist unit, the automated steering control torque applied based on a determined phase of steering control operation and driver inputs wherein the driver inputs comprise driver steering torque and torque rate.

5. The method of claim 2, further comprising:
configuring a labeling module to label data offline to send labeled data to the DNN, and
in response to a control command assist torque signal, sending classified intervention phase information corresponding to a region to apply a varying amount of steering override torque by the driver override determination module.

6. The method of claim 5, further comprising:
configuring a lateral control module to generate steering control torque based at least on inputs comprising the desired path of the vehicle, the predicted dynamics of the vehicle, and a driver override flag.

7. The method of claim 6, wherein the driver override flag is generated by the driver override determination module.

8. A system comprising:
a processing unit disposed of in a vehicle comprising one or more processors configured by programming instructions encoded on non-transient computer-readable media in communication with a Deep Neural Network (DNN), the processing unit configured to:
receive a set of vehicle inputs comprising lane data and vehicle sensor interpretation information and driver steering input;
determine at least a desired path of the vehicle based on use of the lane data and vehicle sensor interpretation information;
determine at least a set of a predicted dynamics of the vehicle based on the lane data and vehicle sensor interpretation information; and
override an automated steering control torque based on a phase of steering control operation determined in part by the desired path and predicted dynamics of the vehicle, and by information of a corresponding intervening phase classified in the DNN.

9. The system of claim 8, further comprising:
the processing unit configured to:
determine a desired path of the vehicle based on the lane data and vehicle sensor interpretation information.

10. The system of claim 9, further comprising:
the processing unit configured to:
generate a set of curvature parameters, and a vehicle heading and position module to generate a set of heading parameters to store in a decision matrix wherein both sets of parameters are used to determine when to implement an override action, the automated steering control torque applied based on a determined phase of steering control operation and driver inputs wherein the driver inputs comprise driver steering torque and torque rate.

11. The system of claim 10, further comprising:
the processing unit configured to:
send labeled data determined offline to the DNN, and
in response to a control command torque-assist signal, send classified intervention phase information corresponding to a region for varying driver override thresholds based on a driver applied steering torque and torque rate.

12. The system of claim 11, further comprising:
the processing unit configured to:
generate steering control torque based at least on a set of inputs comprising the desired path of the vehicle, the predicted dynamics of the vehicle, and a driver override flag.

13. The system of claim 12, further comprising:
the processing unit configured to:
generate a driver override flag based at least on a set of inputs comprising the desired path of the vehicle, the predicted dynamics of the vehicle, and a driver override flag.

14. A vehicle apparatus, comprising a steering assist unit comprising one or more processors and non-transient computer-readable media encoded with programming instructions, the steering assist unit is configured to:
receive a set of vehicle inputs comprising lane data and vehicle sensor interpretation information and driver steering input;
determine at least a desired path of the vehicle based on use of the lane data and vehicle sensor interpretation information;
determine at least a set of a predicted dynamics of the vehicle based on the lane data and vehicle sensor interpretation information;
override an automated steering control torque based on a phase of steering control operation determined in part by a driver input, desired path and predicted dynamics of the vehicle, and by information of a corresponding intervening phase classified in a DNN; and
in response to a determination to override the automated steering control torque, cease application of the steering control torque for automated steering assist based on a determined phase of steering control operation and a variable amount of driver input into vehicle control systems.

15. The vehicle apparatus of claim 14, further comprising:
the steering assist unit configured to:
determine a blended path of the vehicle based on the lane data and vehicle sensor interpretation information.

16. The vehicle apparatus of claim 15, further comprising:
the steering assist unit configured to:
generate a set of curvature parameters, and a vehicle heading and position module to generate a set of heading parameters to store in a decision matrix wherein both sets of parameters are used to determine when to implement an override action, the automated steering control torque applied based on a determined phase of steering control operation and driver inputs wherein the driver inputs comprise driver steering torque and torque rate.

17. The vehicle apparatus of claim 16, further comprising:
the steering assist unit configured to:
send labeled data determined offline to the DNN, and
in response to a control command torque-assist signal, send classified intervention phase information corresponding to a region for varying driver override thresholds based on a driver applied steering torque and torque rate.

18. The vehicle apparatus of claim 17, further comprising:
the steering assist unit configured to:
generate steering control torque based at least on a set of inputs comprising the desired path of the vehicle, the predicted dynamics of the vehicle, and a driver override flag.

19. The vehicle apparatus of claim 18, further comprising:
the steering assist unit configured to:
generate a driver override flag based at least on a set of inputs comprising the desired path of the vehicle, the predicted dynamics of the vehicle, and a driver override flag.

20. The vehicle apparatus of claim 15, further comprising:
the steering assist unit configured to:
determine a path of the vehicle based on the lane data and vehicle sensor interpretation information.
